(19) United States
(12) Patent Application Publication
(10) Pub. No.: US 2009/0303350 A1
(43) Pub. Date: Dec. 10, 2009

(54) MULTI-CHANNEL SOUND COLLECTING APPARATUS, MULTI-CHANNEL SOUND REPRODUCING APPARATUS, AND MULTI-CHANNEL SOUND COLLECTING AND REPRODUCING APPARATUS

(75) Inventor: Yasuhiro Terada, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/914,858

(22) PCT Filed: May 30, 2006
(86) PCT No.: PCT/JP2006/310741

§ 371 Date: Nov. 19, 2007

(30) Foreign Application Priority Data
Jun. 1, 2005 (JP) 2005-161764

(51) Int. Cl. H04N 5/76

(52) U.S. Cl. 348/231.4; 348/E05.031

(57) ABSTRACT

It is an object of the present invention to provide a multi-channel sound collecting apparatus, a multi-channel sound reproducing apparatus, and a multi-channel sound collecting and reproducing apparatus for storing into a storage medium sound signals and a zoom control signal in synchronization with the time at which the imaging device is zoom-operated and the time at which the multi-channel sound collecting unit collects the sounds and capable of controlling the sound signals in accordance with the zoom control signal when the sounds are reproduced.

The multi-channel sound collecting and reproducing apparatus comprises a multi-channel sound collecting unit 111 for collecting sounds incoming from a circumstance of an imaging device and generating sound signals indicative of the sounds, a sound collecting signal storing and reading unit 120 for storing and reading a sound signal and a zoom control signal in synchronization with the time at which the imaging device is zoom-operated and the time at which the multi-channel sound collecting unit collects the sound, a gain control unit 123 for controlling the sound signal for each of channels, and a mode switching unit 122 for allowing the gain control unit 123 to operate in a zoom reproducing mode, and allowing the gain control unit 123 to operate in a predetermined reproducing mode.

### TECHNICAL FIELD OF THE INVENTION

The present invention relates to a multi-channel sound collecting apparatus, a multi-channel sound reproducing apparatus, and a multi-channel sound collecting and reproducing apparatus for collecting and reproducing a multi-channel sound, and more particularly to a multi-channel sound collecting apparatus, a multi-channel sound reproducing apparatus, and a multi-channel sound collecting and reproducing apparatus capable of recording sounds and images in accordance with a zoom operation.

### DESCRIPTION OF THE RELATED ART

Conventionally, in a multi-channel sound collecting apparatus such as, for example, a VTR equipped with a multi-channel camera unit, a sound processing in response to a zoom operation (hereinlater simply referred to as “zoom signal processing”) is carried out while a sound is being collected but not while the sound is being reproduced. This means that the zoom signal processing is carried out in such a way that sounds collected in response to a zoom operation are signal-processed and stored in a predetermined storage medium while the sounds are being collected and the sounds thus stored are simply reproduced while the sound is being reproduced (see, for example, patent document 1 and patent document 2).

FIG. 19 is a block diagram showing a conventional multi-channel sound collecting and reproducing apparatus disclosed in the patent document 1. As shown in FIG. 19, in the conventional multi-channel sound collecting and reproducing apparatus 1a, a zoom lens control circuit 1a7 is adapted to generate a zoom lens control signal in accordance with information indicative of a zoom operation (hereinlater simply referred to as “zoom operation information”) inputted from a microprocessor 1a8, and a zoom lens 1a6 is controlled to have a focal distance of a lens changed in accordance with the zoom lens control signal.

A zoom position voltage generating circuit 1a5 is adapted to convert a current zoom into a voltage to be further outputted to a synthesizing ratio and gain control circuit 1a3, and an enhancer (low and high range component enhancing control circuit) 1a4. Here, it is assumed that the current zoom between a maximum telescopic focal distance and a maximum wide-angle focal distance is represented with reference to the maximum telescopic focal distance.

The synthesizing ratio and gain control circuit 1a3 is adapted to control a synthesizing ratio and a gain of sound data in such a way that a stereo sound inputted from a stereo microphone signal processing circuit 1a1 becomes predominantly when the current zoom is set at the maximum telescopic focal distance and a monaural sound inputted from a super-directional microphone signal processing circuit 1a2 becomes predominant when the current zoom is set at the maximum wide-angle focal distance. Further, the synthesizing ratio of the stereo sound and the monaural sound is continuously switched so that the sound level is increased in accordance with the zoomed image as the zoom as the current zoom is changed between the maximum telescopic focal distance and the maximum wide-angle focal distance.

FIG. 20 is a block diagram showing a conventional multi-channel sound collecting apparatus disclosed in the patent document 2. As shown in FIG. 20, in the conventional multi-channel sound collecting apparatus 1b, a zoom lens 1b7 is controlled to have a focal distance of the zoom lens 1b7 changed in accordance with a zoom lens control signal inputted from a control circuit 1b3.

A sound is controlled in accordance with the zoom operation information in cooperation with a middle microphone coefficient multiplying device 1b4a, a side microphone coefficient multiplying device 1b4b, and a matrix circuit 1b5 in such a way that the synthesizing ratio of sounds respectively inputted from a middle microphone 1b1 and a side microphone 1b2 is changed. This means that the middle microphone coefficient multiplying device 1b4a is adapted to multiply the sound outputted from the middle microphone 1b1 by a predetermined coefficient K and the side microphone coefficient multiplying device 1b4b is adapted to multiply the sound outputted from the side microphone 1b2 by a predetermined coefficient (1−K), and the matrix circuit 1b5 is adapted to calculate a sum of and a difference between the signal outputted from the middle microphone coefficient multiplying device 1b4a and the side microphone coefficient multiplying device 1b4b, to be outputted to respective channel speakers.

In the concrete, the matrix circuit 1b5 is adapted to output signals l and r, in accordance with expressions (1a) and (b) as follows.

l=K×(L+R)+(−K)(L−R) (a1)

r=K×(L+R)−(1−K)(L−R) (a1)

Here, (L+R) is intended to mean an output from the middle microphone 1b1, (L−R) is intended to mean an output from the side microphone 1b2, l is intended to means a sound outputted from a left channel terminal 1b6a, and a r is intended to mean a sound outputted from a right channel terminal 1b6b. K is a value equal to or greater than 0 but equal to or less than 1.

The control circuit 1b3 is designed to control a field angle of the zoom lens 1b7 as well as the sound so that a zoom effect is expressed in the sound in response to the field angle. This means that the sound is controlled in such a way that the coefficient K set in the middle microphone coefficient multiplying device 1b4a and the side microphone coefficient multiplying device 1b4b is changed in accordance with the zoom operation. The coefficient K is set at 0.5 so that a normal stereo sound is outputted when the current zoom is set at the maximum wide-angle focal distance while, on the other hand, the coefficient K is set at 1 so that a unidirectional monaural sound is outputted when the current zoom is set at the maximum telescopic focal distance.

Patent Document 1: Patent Laid-Open Publication No. 2004-328052

Patent Document 2: Japanese Patent No. 3109938.

### DISCLOSURE OF THE INVENTION

### Problems to be Solved by the Invention

The conventional multi-channel sound collecting and reproducing apparatus, however, encounters a drawback in that a zoom of the sound cannot be changed while the sound is reproduced, resulting from the fact that the sound signal already zoom-processed is stored in the storage medium. This leads to another drawback that a user cannot listen to whole sounds of, for example, a concert hall while images are displayed in a zoom-in state when reproducing the images and the sounds which have been recorded in, for example, an orchestra concert. In the concrete, the user cannot listen to whole sounds of the orchestra performance in the concert hall while, for example, a particular person is displayed in a zoom-in state.

The present invention is made for the purpose of solving these drawbacks, and it is an object of the present invention to provide a multi-channel sound collecting apparatus, a multi-channel sound reproducing apparatus, and a multi-channel sound collecting and reproducing apparatus for storing into a storage medium sound signals and a zoom control signal in synchronization with the time at which the imaging device is zoom-operated and the time at which the multi-channel sound collecting unit collects the sounds, and capable of controlling the sound signals in accordance with the zoom control signal when the sounds are reproduced.

### Means for Solving the Problems

In accordance with a first aspect of the present invention, there is provided a multi-channel sound collecting apparatus according to the present invention, comprising: a multi-channel sound collecting unit for collecting sounds incoming from a circumstance of an imaging device capable of operatively zooming in and out an image, and generating sound signals indicative of said sounds; and a sound collecting signal storing unit for receiving a zoom control signal from said imaging device, and a sound signal from said multi-channel sound collecting unit, and storing into a storage medium said zoom control signal and said sound signal in synchronization with the time at which said imaging device is zoom-operated and the time at which said multi-channel sound collecting unit collects said sound.

The multi-channel sound collecting apparatus according to the present invention thus constructed can control the sound signals in accordance with the zoom control signal when the sounds are reproduced from the storage medium, resulting from the fact that the sound collecting signal storing unit is adapted to store the sounds of respective channels and the zoom control signal in such a manner that the sound signals can be read independent from the zoom control signal.

Further, in the multi-channel sound collecting apparatus according to the present invention, said multi-channel sound collecting unit may include a plurality of directional microphones for collecting sounds incoming from a plurality of directions of said circumstance of said imaging device.

The multi-channel sound collecting apparatus according to the present invention thus constructed makes it possible for the sound signals to be reproduced along with a zoom changing function, thereby enhancing realistic sensation, easily responding to user's preference, in addition to the capability of controlling the sound signals in accordance with the zoom control signal when the sounds are reproduced from the storage medium, resulting from the fact that sounds from a plurality of directions including a direction of taking the image are collected and recorded, and the sound collecting signal storing unit is adapted to store the sounds of respective channels and the zoom control signal in such a manner that the sound signals can be read independent from the zoom control signal.

Further, in the multi-channel sound collecting apparatus according to the present invention, said multi-channel sound collecting unit may include a pair of directional microphones for collecting sounds incoming from left and right directions of said imaging device.

The multi-channel sound collecting apparatus according to the present invention thus constructed makes it possible for the sound signals to be reproduced along with a zoom changing function, thereby enhancing realistic sensation, easily responding to user's preference, in addition to the capability of controlling the sound signals in accordance with the zoom control signal when the sounds are reproduced from the storage medium, resulting from the fact that that sounds incoming from left and right directions of said imaging device are collected and recorded, and the sound collecting signal storing unit is adapted to store the sounds of respective channels and the zoom control signal in such a manner that the sound signals can be read independent from the zoom control signal.

Further, in the multi-channel sound collecting apparatus according to the present invention, said multi-channel sound collecting unit may include a directional microphone for collecting sounds from an image taking direction of said imaging device.

The multi-channel sound collecting apparatus according to the present invention thus constructed can be manufactured in simple construction, in addition to the capability of controlling the sound signals in accordance with the zoom control signal when the sounds are reproduced from the storage medium, resulting from the fact that the multi-channel sound collecting unit is constituted by the directional microphone for collecting sounds from an image taking direction of said imaging device, sounds incoming from left and right directions of said imaging device are collected and recorded, and the sound collecting signal storing unit is adapted to store the sounds of respective channels and the zoom control signal in such a manner that the sound signals can be read independent from the zoom control signal.

Further, in the multi-channel sound collecting apparatus according to the present invention, said sound collecting signal storing unit may multiplex said sound signal with said zoom control signal, and store said sound signal multiplexed with said zoom signal into said storage medium.

The multi-channel sound collecting apparatus according to the present invention thus constructed can reduce additional storage area for storing therein the zoom control signal, in addition to the capability of controlling the sound signals in accordance with the zoom control signal when the sounds are reproduced from the storage medium, resulting from the fact that the sound collecting signal storing unit is adapted to multiplex the sound signal with the zoom control signal, and store the sound signal thus multiplexed with the zoom signal into the storage medium, the sound collecting signal storing unit is adapted to store the sounds of respective channels and the zoom control signal in such a manner that the sound signals can be read independent from the zoom control signal.

In accordance with a second aspect of the present invention, there is provided a multi-channel sound reproducing apparatus comprising: a collected signal reading unit for reading a zoom control signal and a sound signal from a storage medium; a gain control unit for controlling said sound signal for each of channels; and a mode switching unit for assuming a plurality of states including a state of allowing said gain control unit to receive said zoom control signal from said collected signal reading unit, to have said gain control unit operate in a zoom reproducing mode, and a state disallowing said gain control unit to receive said zoom control signal from said collected signal reading unit, to have said gain control unit operate in a predetermined reproducing mode.

The multi-channel sound reproducing apparatus according to the present invention thus constructed can change a zoom of sounds to any one of zooms such as, for example, a zoom at the time that the sounds are collected, a zoom set by a user including a passing through zoom, and the like, while the sounds are reproduced, resulting from the fact that the collected signal reading unit is operative to read a zoom control signal and sound signals of respective channels independent from one another, and the zoom reproducing mode and the predetermined reproducing mode can be switched through the mode switching unit.

Further, in the multi-channel sound reproducing apparatus according to the present invention, said gain control unit may include a multiplying device for multiplying said sound signal by a gain, and gain setting means for setting said gain in accordance with said zoom control signal.

The multi-channel sound reproducing apparatus according to the present invention thus constructed can multiply a sound signal by a gain in accordance with the zoom control signal, resulting from the fact that the collected signal reading unit is operative to read a zoom control signal and sound signals of respective channels independent from one another, and the zoom reproducing mode and the predetermined reproducing mode can be switched through the mode switching unit.

Further, in the multi-channel sound reproducing apparatus according to the present invention, said control unit may set a gain of a sound signal indicative of a sound from an image taking direction higher than gains of sound signals indicative of sounds from directions other than said image taking direction, when reproducing sounds which were collected while a lens of said imaging device was placed at a maximum telescopic focal distance.

The multi-channel sound reproducing apparatus according to the present invention thus constructed can change a zoom of sounds to any one of zooms such as, for example, a zoom at the time that the sounds are collected, a zoom set by a user including a passing through zoom, and the like, while the sounds are reproduced, as well as makes it possible for the sound signals to be reproduced along with a zoom changing function, thereby enhancing realistic sensation, easily responding to user's preference, resulting from the fact that the collected signal reading unit is operative to read a zoom control signal and sound signals of respective channels independent from one another, and the zoom reproducing mode and the predetermined reproducing mode can be switched through the mode switching unit, and the sounds from a plurality of directions including a direction of taking the image are collected and recorded.

Further, in the multi-channel sound reproducing apparatus according to the present invention, said control unit may set gains of a pair of sound signals respectively indicative of sounds from left and right directions of said imaging device in such a manner that said pair of sound signals are reproduced in stereo, when reproducing sounds which were collected while a lens of said imaging device was placed at a maximum wide-angle focal distance, and said control unit may set gains of said pair of sound signals respectively indicative of sounds from left and right directions of said imaging device in such a manner that said pair of sound signals are reproduced in monaural, when reproducing sounds which were collected while a lens of said imaging device was placed at a maximum telescopic focal distance.

The multi-channel sound reproducing apparatus according to the present invention thus constructed can change a zoom of sounds to any one of zooms such as, for example, a zoom at the time that the sounds are collected, a zoom set by a user including a passing through zoom, and the like, while the sounds are reproduced, as well as makes it possible for the sound signals to be reproduced along with a zoom changing function, thereby enhancing realistic sensation, easily responding to user's preference, resulting from the fact that the collected signal reading unit is operative to read a zoom control signal and sound signals of respective channels independent from one another, and the zoom reproducing mode and the predetermined reproducing mode can be switched through the mode switching unit, and the sounds from left and right directions of said imaging device are collected and recorded.

Further, in the multi-channel sound reproducing apparatus according to the present invention, said control unit may set gains of a plurality of sound signals respectively indicative of a plurality of sounds of a circumstance of said imaging device in accordance with said zoom control signal read from said storage medium, when reproducing sounds which were collected while a lens of said imaging device was placed in between maximum wide-angle focal distance and a maximum telescopic focal distance.

The multi-channel sound reproducing apparatus according to the present invention thus constructed can change a zoom of sounds to any one of zooms such as, for example, a zoom at the time that the sounds are collected, a zoom set by a user including a passing through zoom, and the like, while the sounds are reproduced, as well as reproduce sounds of a single channel perceptively in accordance with a zoom state at the time that the sounds are collected, resulting from the fact that the collected signal reading unit is operative to read a zoom control signal and sound signals of respective channels independent from one another, and the zoom reproducing mode and the predetermined reproducing mode can be switched through the mode switching unit, and the gain of the sound signal to be reproduced is controlled in accordance with the zoom state.

Further, the multi-channel sound reproducing apparatus according to the present invention, may further comprise a frequency characteristic control unit for controlling frequency spectra of sound signals outputted from said gain control unit for respective channels.

The multi-channel sound reproducing apparatus according to the present invention thus constructed can change a zoom of sounds to any one of zooms such as, for example, a zoom at the time that the sounds are collected, a zoom set by a user including a passing through zoom, and the like, while the sounds are reproduced, as well as makes it possible for realistic sensation to be expressed in accordance with a zoom state, resulting from the fact that the collected signal reading unit is operative to read a zoom control signal and sound signals of respective channels independent from one another, the zoom reproducing mode and the predetermined reproducing mode can be switched through the mode switching unit, and the frequency characteristic control unit controls the frequency spectra in accordance with the zoom control signal.

In accordance with a third aspect of the present invention, there is provided a multi-channel sound collecting and reproducing apparatus, comprising: a multi-channel sound collecting unit, mounted on an imaging device capable of operatively zooming in and out an image, for collecting sounds incoming from a circumstance of said imaging device, and generating sound signals indicative of said sounds; a sound collecting signal storing and reading unit for receiving a zoom control signal from said imaging device and a sound signal from said multi-channel sound collecting unit, and storing into a storage medium said zoom control signal and said sound signal in synchronization with the time at which said imaging device is zoom-operated and the time at which said multi-channel sound collecting unit collects said sound, and reading said zoom control signal and said sound signal from said storage medium; a gain control unit for controlling said sound signal for each of channels; and a mode switching unit for assuming a plurality of states including a state of allowing said gain control unit to receive said zoom control signal from said sound collecting signal storing and reading unit, to have said gain control unit operate in a zoom reproducing mode, and a state disallowing said gain control unit to receive said zoom control signal from said sound collecting signal storing and reading unit, to have said gain control unit operate in a predetermined reproducing mode, and in which said sound collecting signal storing and reading unit is operative to control said sound signal for each of channels in accordance with said zoom control signal when said mode switching unit assumes on said zoom reproducing mode and control said sound signal for each of channels in accordance with a predetermined control method when said mode switching unit assumes on said predetermined reproducing mode.

The multi-channel sound collecting and reproducing apparatus according to the present invention thus constructed can change a zoom of sounds, while the sounds are reproduced, resulting from the fact that the sound collecting signal storing unit is operative to store the sounds of respective channels and the zoom control signal in such a manner that the sound signals can be read independent from the zoom control signal, the collected signal reading unit is operative to read a zoom control signal and sound signals of respective channels independent from one another, and the zoom reproducing mode and the predetermined reproducing mode can be switched through the mode switching unit.

Further, in the multi-channel sound collecting and reproducing apparatus according to the present invention, said gain control unit may include a multiplying device for multiplying said sound signal by a gain, and gain setting means for setting said gain in accordance with said zoom control signal.

The multi-channel sound collecting and reproducing apparatus according to the present invention thus constructed can multiply the sound signal with a gain in accordance with the zoom control signal, resulting from the fact that the sound collecting signal storing unit is operative to store therein sound signals of respective channels and the zoom control signal in such a manner that the sound signals of respective channels can be later read independent from the zoom control signal, the collected signal reading unit is operative to read a zoom control signal and sound signals of respective channels independent from one another, and the zoom reproducing mode and the predetermined reproducing mode can be switched through the mode switching unit.

Further, in the multi-channel sound collecting and reproducing apparatus according to the present invention, said multi-channel sound collecting unit may include a plurality of directional microphones for collecting sounds incoming from a plurality of directions of said circumstance of said imaging device.

The multi-channel sound collecting and reproducing apparatus according to the present invention thus constructed can control the sound signals in accordance with the zoom control signal when the sounds are reproduced from the storage medium, as well as makes it possible for the sound signals to be reproduced along with a zoom changing function, thereby enhancing realistic sensation, easily responding to user's preference, resulting from the fact that the collected signal reading unit is operative to read a zoom control signal and sound signals of respective channels independent from one another, and the zoom reproducing mode and the predetermined reproducing mode can be switched through the mode switching unit.

Further, in the multi-channel sound collecting and reproducing apparatus according to the present invention, said multi-channel sound collecting unit may include a pair of directional microphones for collecting sounds incoming from left and right directions of said imaging device.

The multi-channel sound collecting and reproducing apparatus according to the present invention thus constructed can control the sound signals in accordance with the zoom control signal when the sounds are reproduced from the storage medium, as well as makes it possible for the sound signals to be reproduced along with a zoom changing function, thereby enhancing realistic sensation, easily responding to user's preference, resulting from the fact that the sound collecting signal storing unit is operative to store therein sound signals of respective channels and the zoom control signal in such a manner that the sound signals of respective channels can be later read independent from the zoom control signal, the collected signal reading unit is operative to read a zoom control signal and sound signals of respective channels independent from one another, and the zoom reproducing mode and the predetermined reproducing mode can be switched through the mode switching unit.

Further, in the multi-channel sound collecting and reproducing apparatus according to the present invention, said multi-channel sound collecting unit may include a directional microphone for collecting sounds from an image taking direction of said imaging device.

The multi-channel sound collecting and reproducing apparatus according to the present invention thus constructed can control the sound signals in accordance with the zoom control signal when the sounds are reproduced from the storage medium as well as can be manufactured in simple construction, resulting from the fact that the sound collecting signal storing unit is operative to store therein sound signals of respective channels and the zoom control signal in such a manner that the sound signals of respective channels can be later read independent from the zoom control signal, the collected signal reading unit is operative to read a zoom control signal and sound signals of respective channels independent from one another, the zoom reproducing mode and the predetermined reproducing mode can be switched through the mode switching unit, and the multi-channel sound collecting unit is constituted by a single directional microphone.

Further, in the multi-channel sound collecting and reproducing apparatus according to the present invention, said sound collecting signal storing unit may multiplex said sound signal with said zoom control signal, and store said sound signal multiplexed with said zoom signal into said storage medium.

The multi-channel sound collecting and reproducing apparatus according to the present invention thus constructed can change a zoom of sounds while the sounds are reproduced as well as reduce additional storage area for storing therein the zoom control signal, resulting from the fact that the sound collecting signal storing unit is operative to store therein sound signals and the zoom control signal in such a manner that the sound signals can be later read independent from the zoom control signal, the predetermined reproducing mode can be switched through the mode switching unit, and said sound collecting signal storing unit is operative to store said sound signal multiplexed with said zoom signal.

Further, in the multi-channel sound collecting and reproducing apparatus according to the present invention, said control unit may set a gain of a sound signal indicative of a sound from an image taking direction higher than gains of sound signals indicative of sounds from directions other than said image taking direction, when reproducing sounds which were collected while a lens of said imaging device was placed at a maximum telescopic focal distance.

The multi-channel sound collecting and reproducing apparatus according to the present invention thus constructed can change a zoom of sounds while the sounds are reproduced from the storage medium as well as makes it possible for the sound signals to be reproduced along with a zoom changing function, thereby enhancing realistic sensation, easily responding to user's preference, resulting from the fact that the sound collecting signal storing unit is operative to store therein sound signals of respective channels and the zoom control signal in such a manner that the sound signals of respective channels can be later read independent from the zoom control signal, the collected signal reading unit is operative to read a zoom control signal and sound signals of respective channels independent from one another, the zoom reproducing mode and the predetermined reproducing mode can be switched through the mode switching unit, and a plurality of directions including a direction of taking the image are collected and reproduced.

Further, in the multi-channel sound collecting and reproducing apparatus according to the present invention, said control unit may set gains of a pair of sound signals respectively indicative of sounds from left and right directions of said imaging device in such a manner that said pair of sound signals are reproduced in stereo, when reproducing sounds which were collected while a lens of said imaging device was placed at a maximum wide-angle focal distance, and said control unit may set gains of said pair of sound signals respectively indicative of sounds from left and right directions of said imaging device in such a manner that said pair of sound signals are reproduced in monaural, when reproducing sounds which were collected while a lens of said imaging device was placed at a maximum telescopic focal distance.

The multi-channel sound collecting and reproducing apparatus according to the present invention thus constructed can change a zoom of sounds while the sounds are reproduced from the storage medium as well as makes it possible for the sound signals to be reproduced along with a zoom changing function, thereby enhancing realistic sensation, easily responding to user's preference, resulting from the fact that the sound collecting signal storing unit is operative to store therein sound signals of respective channels and the zoom control signal in such a manner that the sound signals of respective channels can be later read independent from the zoom control signal, the collected signal reading unit is operative to read a zoom control signal and sound signals of respective channels independent from one another, the zoom reproducing mode and the predetermined reproducing mode can be switched through the mode switching unit, and the sounds from left and right directions of said imaging device are collected and recorded.

Further, in the multi-channel sound collecting and reproducing apparatus according to the present invention, said control unit may set gains of a plurality of sound signals respectively indicative of a plurality of sounds of a circumstance of said imaging device in accordance with said zoom control signal read from said storage medium, when reproducing sounds which were collected while a lens of said imaging device was placed in between maximum wide-angle focal distance and a maximum telescopic focal distance.

The multi-channel sound collecting and reproducing apparatus according to the present invention thus constructed can change a zoom of sounds while the sounds are reproduced from the storage medium, as well as reproduce sounds of a single channel perceptively in accordance with a zoom state at the time that the sounds are collected, resulting from the fact that the sound collecting signal storing unit is operative to store therein sound signals and the zoom control signal in such a manner that the sound signals can be later read independent from the zoom control signal, the collected signal reading unit is operative to read a zoom control signal and sound signals of respective channels independent from one another, the zoom reproducing mode and the predetermined reproducing mode can be switched through the mode switching unit.

Further, in the multi-channel sound collecting and reproducing apparatus according to the present invention, may further comprise a frequency characteristic control unit for controlling frequency spectra of sound signals outputted from said gain control unit for respective channels.

The multi-channel sound collecting and reproducing apparatus according to the present invention thus constructed can change a zoom of sounds while the sounds are reproduced from the storage medium, as well as makes it possible for realistic sensation to be expressed in accordance with a zoom state, resulting from the fact that the sound collecting signal storing unit is operative to store therein sound signals of respective channels and the zoom control signal in such a manner that the sound signals of respective channels can be later read independent from the zoom control signal, the collected signal reading unit is operative to read a zoom control signal and sound signals of respective channels independent from one another, the zoom reproducing mode and the predetermined reproducing mode can be switched through the mode switching unit, and the frequency characteristic control unit controls the frequency spectra of the sounds in accordance with the zoom control signal.

### Advantageous Effect of the Invention

The present invention can provide a multi-channel sound collecting apparatus, a multi-channel sound reproducing apparatus, and a multi-channel sound collecting and reproducing apparatus have effects of changing a zoom of the sound signals when the sounds are reproduced, resulting from the fact that the sound collecting signal storing unit is operative to store therein sound signals of respective channels and the zoom control signal in such a manner that the sound signals of respective channels can be later read independent from the zoom control signal, the collected signal reading unit is operative to read a zoom control signal and sound signals of respective channels independent from one another, or the sound collecting signal storing and reading unit is operative to store and read the zoom control signal and the sound signals of respective channels independent from one another.

### BRIEF DESCRIPTION OF THE DRAWINGS

The features and advantages of the present invention will be more clearly understood from the following description taken in conjunction with the accompanying drawings in which:

FIG. 1 is a block diagram showing a construction of a first preferred embodiment of a multi-channel sound collecting apparatus according to the present invention;

FIG. 2 is a graph explaining an example of a zoom control signal stored in the sound collecting signal storing unit 113;

FIG. 3 is a block diagram showing a construction of a first preferred embodiment of a multi-channel sound reproducing apparatus according to the present invention;

FIG. 4 is a block diagram showing an example of a gain control unit 123 of the first preferred embodiment;

FIG. 5 is a graph explaining a coefficient setting method carried out by a gain setting means 123f;

FIG. 6 is a block diagram showing a construction of first preferred embodiment of a multi-channel sound collecting and reproducing apparatus according to the present invention;

FIG. 7 is a block diagram showing a construction of second preferred embodiment of a multi-channel sound collecting apparatus according to the present invention;

FIG. 8 is a block diagram showing a construction of a second preferred embodiment of a multi-channel sound reproducing apparatus according to the present invention;

FIG. 9 is a block diagram showing an example of gain control unit 223 of the second embodiment:

FIG. 10 is a graph explaining an example of a coefficient setting method carried out by a gain setting means 223F;

FIG. 11 is a block diagram showing a construction of a second preferred embodiment of a multi-channel sound collecting and reproducing apparatus according to the present invention;

FIG. 12 is a block diagram showing a construction of a third preferred embodiment of a multi-channel sound collecting apparatus according to the present invention;

FIG. 13 is a block diagram showing a construction of a third preferred embodiment of a multi-channel sound reproducing apparatus according to the present invention;

FIG. 14 is a block diagram showing an example of a gain control unit 323 of the third preferred embodiment;

FIG. 15 is a graph explaining a coefficient setting method carried out by a gain setting means 323F;

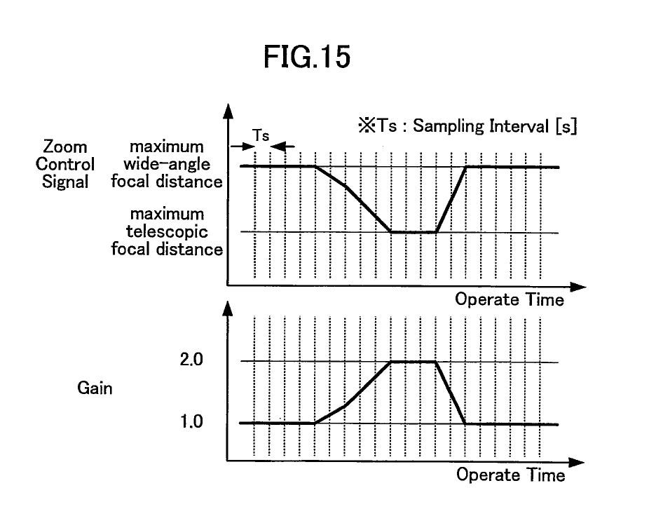

FIG. 16 is a block diagram showing a construction of a third preferred embodiment of a multi-channel sound collecting and reproducing apparatus according to the present invention:

FIG. 17 is a block diagram showing a construction of a fourth preferred embodiment of a multi-channel sound reproducing apparatus according to the present invention;

FIG. 18 is a block diagram showing a construction of a fourth preferred embodiment of a multi-channel sound collecting and reproducing apparatus according to the present invention;

FIG. 19 is a block diagram showing a construction of a conventional multi-channel sound collecting and reproducing apparatus disclosed in the patent document 1; and

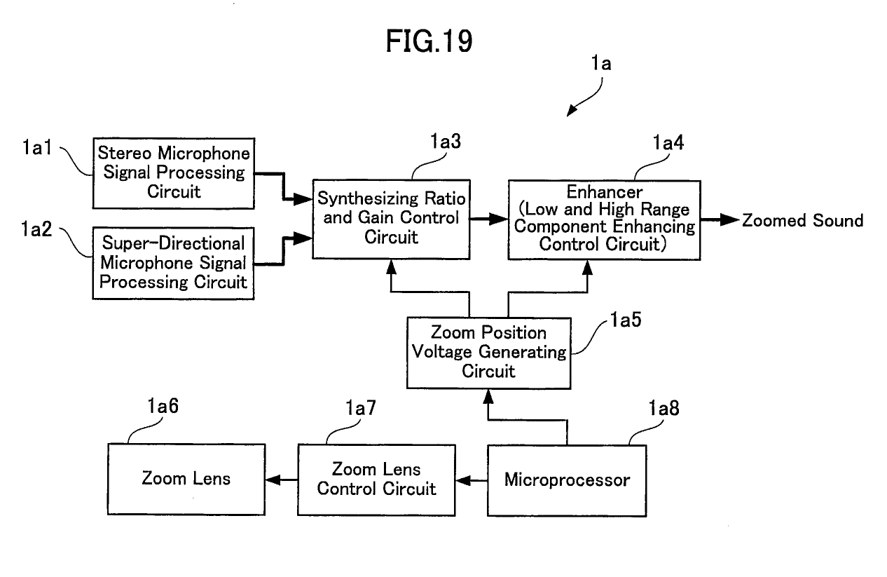

FIG. 20 is a block diagram showing a construction of a conventional multi-channel sound collecting and reproducing apparatus disclosed in the patent document 2.

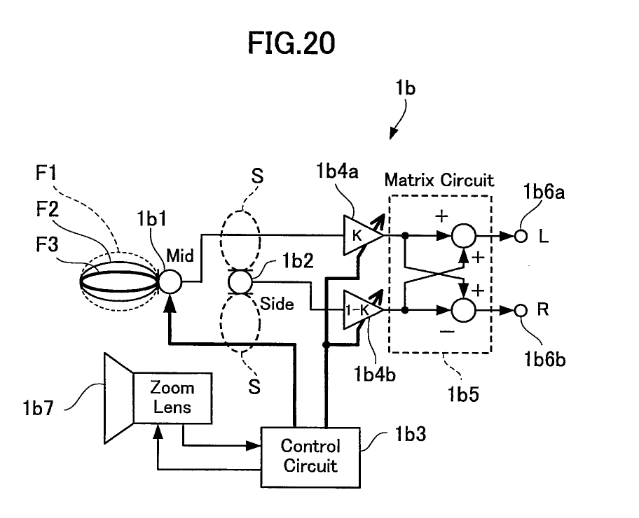

### DESCRIPTION OF THE REFERENCE NUMERALS

1a1b multi-channel sound collecting and reproducing apparatus
1a1 stereo microphone signal processing circuit
1a2 super-directional microphone signal processing circuit
1a3 synthesizing ratio and gain control circuit
1a4 enhancer (low and high range component enhancing control circuit)
1a5 zoom position voltage generating circuit
1a6, 1b7 zoom lens
1a7 zoom lens control circuit
1a8 microprocessor
1b1 middle microphone
1b2 side microphone
1b3 control circuit
1b4a middle microphone coefficient multiplying device
1b4b side microphone coefficient multiplying device
1b5 matrix circuit
1b6a, b left and right channel terminals of the matrix circuit
10, 20, 30, 40 multi-channel sound collecting and reproducing apparatus
11, 21, 31 multi-channel sound collecting apparatus
12, 22, 32, 42 multi-channel sound reproducing apparatus
111, 211, 311 multi-channel sound collecting unit
111a to 111e directional microphone
112, 212, 312 analog-digital converting unit
112a to 112e AD converter
113, 213, 313 sound collecting signal storing unit
120, 220, 320, 420 sound collecting signal storing and reading unit

### DESCRIPTION OF THE PREFERRED EMBODIMENTS

Preferred embodiments of a multi-channel sound collecting apparatus, a multi-channel sound reproducing apparatus, and a multi-channel sound collecting and reproducing apparatus will be described hereinafter with reference to the drawings.

### First Preferred Embodiment

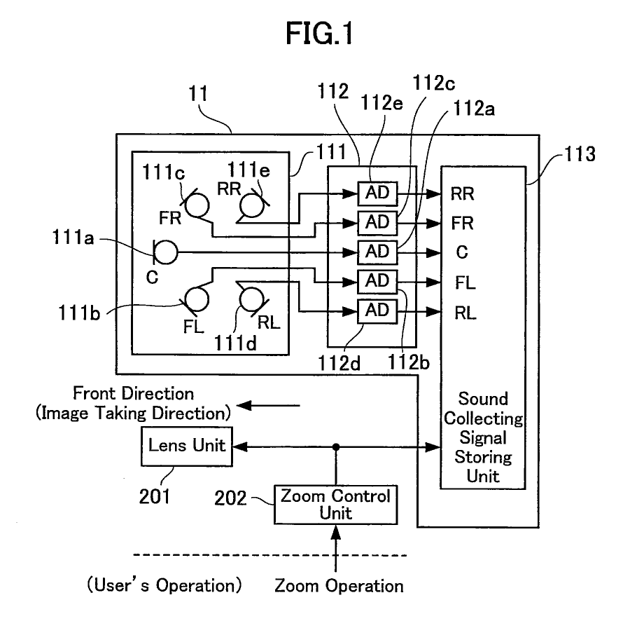

Referring to FIG. 1 of the drawings, there is shown a first preferred embodiment of the multi-channel sound collecting apparatus according to the present invention.

The present embodiment of the multi-channel sound collecting apparatus according to the present invention is mounted on an imaging device capable of carrying out a zoom operation and adapted to collect sounds incoming from a circumstance of the imaging device. As clearly seen from FIG. 1, the imaging device comprises a zoom lens unit 201 capable of changing a focal distance of a lens from a maximum telescopic focal distance to a maximum wide-angle focal distance, and a zoom control unit 202 for controlling the zoom lens unit 201.

As clearly seen from FIG. 1, the multi-channel sound collecting apparatus 11 comprises a multi-channel sound collecting unit 111 having one or more directivity microphones, a analog-digital converting unit 112 for converting analog sound signals collected by the one or more directional microphones into digital sound signals, a sound collecting signal storing unit 113 for storing therein the digital sound signals and a zoom control signal generated in response to the zoom operation. The aforementioned imaging device includes a zoom lens unit 201 capable of changing a focal distance of a lens from a maximum telescopic focal distance to a maximum wide-angle focal distance, and a zoom control unit 202 for controlling the zoom lens unit 201.

The multi-channel sound collecting unit 111 includes a directional microphone 111a for collecting sounds from a direction, which the imaging device is facing to, a directional microphone 111b for collecting sounds from a front left direction of the imaging device, a directional microphone 111c for collecting sounds from a front right direction of the imaging device, a directional microphone 111d for collecting sounds from a rear left direction of the imaging device, and a directional microphone 111e for collecting sounds from a rear right direction of the imaging device.

In order to enhance the zoom effect, it is preferable that the directivity of the directional microphone 111a should be sharpened. Further, one or more of the directional microphones 111a to 111e may be replaced with a plurality of nondirectional microphones and a signal processing means for carrying out signal-processing such as, for example, a phasing processing, and/or the like, so as to provide the directivity.

The analog-digital converting unit 112 includes a plurality of analog-digital converters (hereinlater simply referred to as “AD converters”) 112a to 112e respectively provided for the directional microphones 111a to 111e forming part of the multi-channel sound collecting unit 111, and respectively adapted to convert analog sound signals collected by the directional microphones 111a to 111e into digital sound signals.

The sound collecting signal storing unit 113 is adapted to receive the digital sound signals outputted from the analog-digital converting unit 112 and the zoom control signal outputted from the zoom control unit 202, and store the digital sound signals and the zoom control signal in a predetermined storage medium such as, for example, a disk, a tape, and/or the like in such a manner that a time, at which the imaging device is operated to carry out a zoom function, is oriented to a time, at which the sounds are collected by the multi-channel sound collecting unit 111. The digital sound date thus stored is stored in storage areas of the aforementioned storage medium respectively corresponding to the directional microphones 111a to 111e (hereinlater simply referred to as “channel specific storage areas”). The sound collecting signal storing unit 113 is designed to store the sound signals and the zoom control signal in the storage medium.

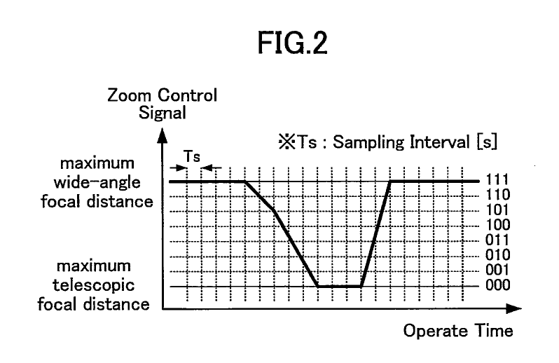

FIG. 2 shows an example of the zoom control signal stored in the sound collecting signal storing unit 113. As clearly seen from FIG. 2, the vertical coordinate axis represents a signal value of the zoom control signal, the horizontal coordinate axis represents time at which the sound signal is collected, and the zoom control signal is represented as a three-bit signal at each of sampling times. The example of the zoom control signal shown in FIG. 2 is changed from the maximum wide-angle focal distance to the and then returned to the maximum wide-angle focal distance wherein the zoom control signal is represented as “000” at the maximum telescopic focal distance and as “111” at the maximum wide-angle focal distance.

It is preferable that lower bits of any one of the storage areas in which the collected sound signals are stored should be used to store the zoom control signal therein, thereby eliminating the need for additional storage areas and thus saving the storage resource. In this case, information whether the zoom control signal is stored or not may be written in a predetermined position of a header of each of the channel specific sound signals. Further, the information whether the zoom control signal is stored or not may be written in lower two bits of each of the sound signals. It is also preferable that the signal should be voice-encoded in conformity with a standardized encoding method such as, for example, AAC (Advanced Audio Coding), or the like, before being stored, thereby saving the required storage areas. Further, the sound collecting signal storing unit 113 may further include a buffer memory for temporarily storing therein a signal to be stored.

The operation of the present embodiment of the multi-channel sound collecting apparatus 11 will be described hereinlater.

As the imaging device starts to take images, sounds are colleted by the directional microphones 111a to 111e from various directions, and inputted to the analog-digital converting unit 112 as analog sound signals. The analog sound signals inputted to the analog-digital converting unit 112 are converted into digital sound signals to be outputted to the sound collecting signal storing unit 113.

In parallel, a zoom control signal is outputted from the zoom control unit 202 to the sound collecting signal storing unit 113. Each of the digital sound signals outputted to the sound collecting signal storing unit 113 is stored in a channel specific storage area of a predetermined storage medium such as, for example, a disk, a tape, and/or the like. Here, each of the digital sound signals and the zoom control signal outputted to the sound collecting signal storing unit 113 may be temporarily stored in a buffer memory before being stored therein. In addition, lower bits of any one of the storage areas in which the collected sound signals are stored may be used to store the zoom control signal therein. Further, the signals may be voice-encoded in conformity with a well-known encoding method, before being stored.

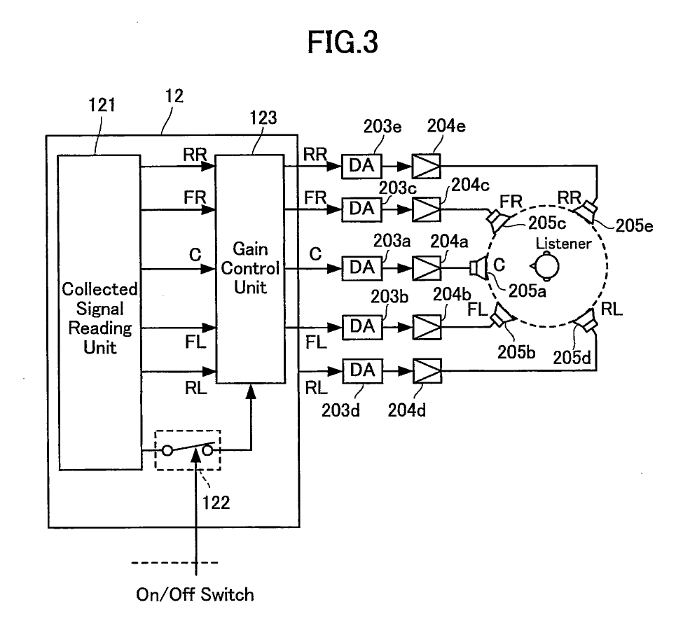

The present embodiment of the multi-channel voice reproducing apparatus is adapted to output sounds after gains of the sounds are controlled, so as to reproduce sounds in accordance with the zoom operation made when the image were taken. FIG. 3 is a block diagram showing a first preferred embodiment of the multi-channel sound reproducing apparatus according to the present invention. As clearly seen from FIG. 3, the present embodiment of the multi-channel sound reproducing apparatus 12 comprises a collected signal reading unit 121 for reading sound signals in association with the zoom control signal from the predetermined storage medium, a mode switching unit 122 for switching one of reproducing modes of reproducing the sound signals read by the collecting signal reading unit 121 to the other, and a gain control unit 123 for controlling a gain of the sound signal in accordance with the reproducing mode specified by the mode switching unit 122.

The collected signal reading unit 121 is adapted to read the zoom control signal and the sound signals for each of channels stored in the channel specific storage areas from the storage medium, and output each of the sound signals in synchronization with the zoom control signal with respect to the time at which each of the sound signals is collected. The sound signals of each channel are outputted to the gain control unit 123, and the zoom control signal is outputted to the mode switching unit 122.

If the zoom control signal and each of the sound signals stored in the voice-encoded format are read from the storage medium, the signals are decoded after being read. In the case that the zoom control signal is stored in lower bits of the channel specific storage area, the lower bits are copied and then outputted as the zoom control signal to the mode switching unit 122.

The multi-channel sound reproducing apparatus 12 is designed to assume tow reproducing modes including a zoom reproducing mode of reproducing the voice signals read by the collected signal reading unit 121 in accordance with the zoom control signal, and a predetermined reproducing mode of reproducing the voice signals read by the collected signal reading unit 121 in a predetermined mode. The mode switching unit 122 is designed to switch the zoom one of the aforementioned reproducing mode and the predetermined reproducing mode to the other.

The mode switching unit 122 is adapted to allow the zoom control signal to be transferred from the collected signal reading unit 121 to the gain control unit 123 in, for example, the zoom reproducing mode. The mode switching unit 122, on the other hand, is adapted to disallow the zoom control signal to be transferred from the collected signal reading unit 121 to the gain control unit 123 in the predetermined reproducing mode.

In the concrete, the mode switching unit 122 may be constituted by a button such as, for example, a hardware button or a button on a touch panel, to be pressed by a user's operation, to have the reproducing mode switched to the other. It is hereinlater assumed that the zoom reproducing mode is selected when the mode switching unit 122 is turned on and the predetermined reproducing mode is selected when the mode switching unit 122 is turned off.

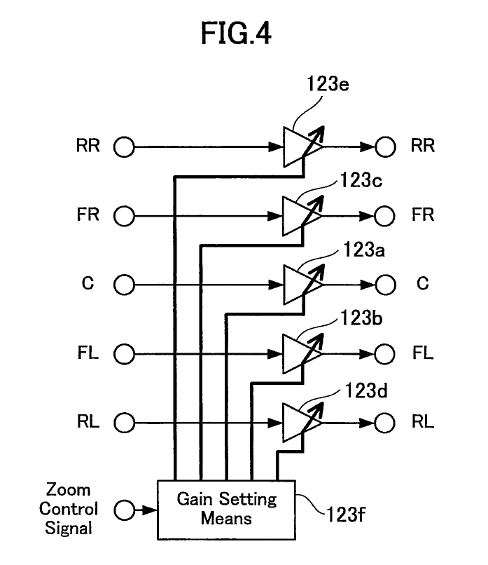

The gain control unit 123 is designed to control gains of the sound signals of respective channels read by the collected signal reading unit 121, in accordance with the zoom control signal in the zoom reproducing mode. The gain control unit 123 is, on the other hand, designed to control gains of the sound signals of respective channels read by the collected signal reading unit 121 in accordance with a predetermined control method in the predetermined reproducing mode. FIG. 4 is a block diagram showing a constructional example of the gain control unit 123 of the present embodiment.

In FIG. 4, the gain control unit 123 includes a plurality of multiplying devices 123a to 123e provided for respective channels, and gain setting means 123f for setting a plurality of coefficients to be multiplied by the sound signals of the respective channels. Gains of the sound signals of the respective channels are controlled through the coefficients set by the gain setting means 123f. In the concrete, the multiplying devices 123a to 123e are designed to multiply the inputted sound signals respectively by the coefficients set by the gain setting means 123f.

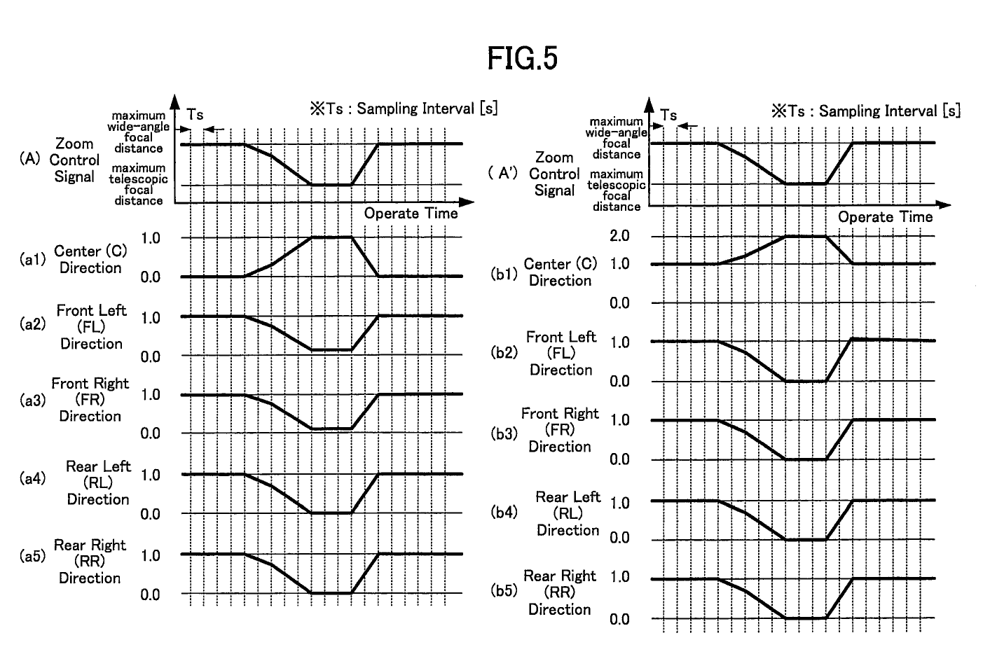

FIG. 5 is a graph explaining the aforementioned setting method. FIG. 5(A) is a graph showing an example of the zoom control signal inputted to the gain setting means 123f. FIGS. 5(a1) to 5(a5) are graphs showing examples of the aforementioned coefficients respectively outputted to the multiplying devices 123a to 123e (hereinlater simply referred to first examples), and FIGS. 5(b1) to 5(b5) are graphs showing another examples of the aforementioned coefficients respectively outputted to the multiplying devices 123a to 123e (hereinlater simply referred to second examples).

The first and second examples are similar in that the gain setting means 123f is adapted to set the coefficients at 1 for all of the multiplying devices 123b to 123e when the current zoom is set at the maximum telescopic focal distance, and at a value in the vicinity of 0 for all of the multiplying devices 123b to 123e when the current zoom is set at the maximum wide-angle focal distance. The first and second examples are different from each other in that the gain setting means 123f is adapted to set the coefficient at 0 in the first example and at 1 in the second example for the multiplying device 123a when the current zoom is set at the maximum telescopic focal distance, and set the coefficient at 1 in the first example and at 2 in the second example for the multiplying device 123a when the current zoom is set at the maximum wide-angle focal distance. Both in the first and second examples, the gain setting means 123f is adapted to set the coefficients in such a manner that the coefficients are changed in accordance with the zoom control signal while the current zoom is changed between the maximum telescopic focal distance and the maximum wide-angle focal distance. The fact that the coefficients are near-continuously changed in accordance with the zoom leads to the fact that the sound levels can be gradually increased or decreased in accordance with the field angle.

If no zoom signal is inputted to the gain setting means 123f, the gain control unit 123 is adapted to set the coefficients for respective multiplying devices 123a to 123e in accordance with predetermined data or a signal inputted through external means, not shown. The signal inputted through the external means may be, for example, a signal generated when a user sets a zoom condition as a result of operating an operation panel, or the like.

The operation of the present embodiment of the multi-channel sound reproducing apparatus 12 will be described hereinlater. At the start of reproducing sounds, the sound signals and the zoom control signal are read by the collected signal reading unit 121 from the storage medium for each of the channels, and the sound signals are outputted in synchronization with the zoom control signal for each of the channels.

The sound signals of each channel are outputted to the gain control unit 123, and the zoom control signal is outputted to the mode switching unit 122. If the zoom control signal and each of the sound signals stored in the voice-encoded format are read from the storage medium, the signals are outputted after being decoded. In the case that the zoom control signal is stored in lower bits of a predetermined channel specific storage area, the lower bits are outputted as the zoom control signal.

The zoom control signal outputted to the mode switching unit 122 is transferred to the gain setting means 123f of the gain control unit 123, and converted by the gain setting means 123f to a plurality of coefficients respectively to be set for the multiplying devices 123a to 123e when the mode switching unit 122 is turned on. The description hereinlater will be directed to an operation under the assumption that the mode switching unit 122 is turned on, viz., in the zoom reproducing mode. The coefficients set in accordance with the zoom control signal are outputted to the multiplying devices 123a to 123e.

The sound signals of the channels outputted to the gain control unit 123 are multiplied by the coefficients set by the gain setting means 123f by the multiplying devices 123a to 123e, and then outputted to an exterior device for each of the channels. The sound signals to be reproduced are thus changed in a zoom state in accordance with the field angle at the time that the images are taken, and then outputted from the multi-channel sound reproducing apparatus 12.

The sound signals of respective channels outputted from the multi-channel sound reproducing apparatus 12 are converted by digital-analog converting units 203a to 203e shown in FIG. 3 into analog sound signals for respective channels, power-amplified by power amplifiers 204a to 204e for respective channels, and audibly outputted by loud speakers 205a to 205e to reproduce a sound field at the time that the images are taken.

The description hereinlater will be directed to an operation under the assumption that the mode switching unit 122 is turned off, viz., in the predetermined reproducing mode. In this case, the zoom signal outputted to the mode switching unit 122 is not transferred to the gain setting means 123f, and the sound signals of respective channels are multiplied by coefficients specified in accordance with predetermined data or a signal inputted through external means, not shown, and then outputted to an exterior device for each of the channels. This operation makes it possible for the sound signals to be reproduced in dependent from the zoom operation at the time that the images are taken. In the concrete, sounds can be reproduced in accordance with user's preference by setting gains of the sounds of respective channels.

Though it has been described in the present embodiment that the multi-channel sound collecting apparatus 11 is adapted to store digital signals in a storage medium, and the multi-channel sound reproducing apparatus 12 is adapted to read the digital signals from the storage medium, to have the digital signals reproduced and outputted therethrough, this does not limit the present invention. The present invention is applicable to the case that analog signals are stored in and read from a storage medium to have the analog signals reproduced, in the same way. In the case that the analog signals are stored, the analog-digital converting unit 112 is omitted in the multi-channel sound collecting apparatus 11, and in the case that the analog signals are reproduced, the digital-analog converting units 203a to 203e are omitted in the multi-channel sound reproducing apparatus 12.

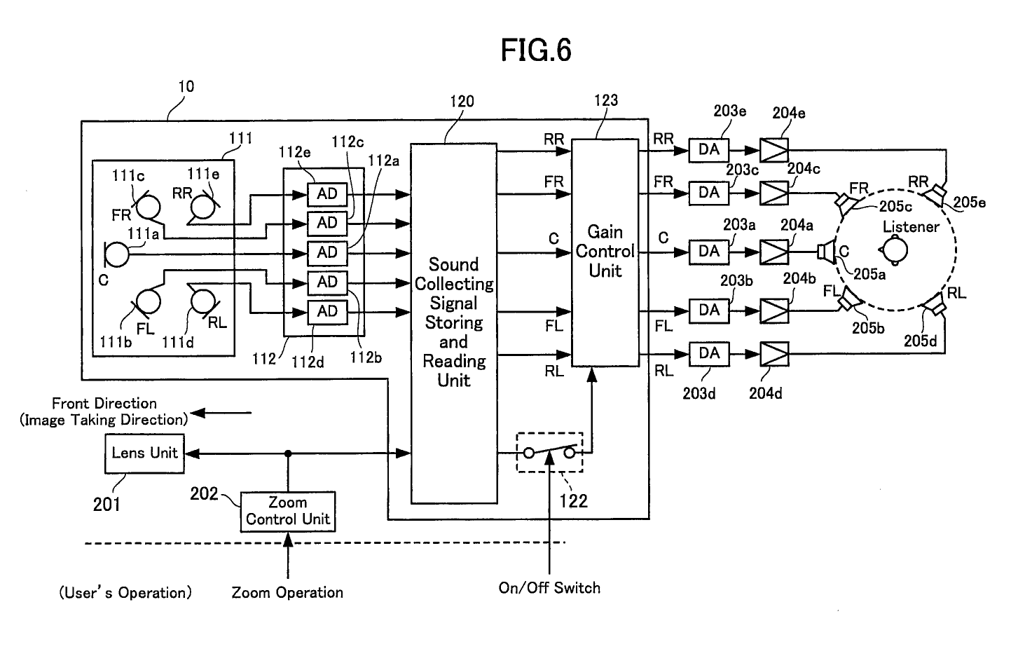

Further, though it has been described in the above that the multi-channel sound collecting apparatus 11 and the multi-channel sound reproducing apparatus 12 are separated from each other, the multi-channel sound collecting apparatus and the multi-channel sound reproducing apparatus may be integrated with each other, for example, as a single multi-channel sound collecting and reproducing apparatus shown in FIG. 6. In this case, the sound collecting signal storing unit and the collected signal reading unit may be constituted by, for example, a single sound collecting signal storing and reading unit 120 for storing therein sounds, voices or the like, as the sound collecting signal storing unit 113, and reading sound signals, as the collected signal reading unit 121. The single sound collecting signal storing and reading unit 120 may be constituted by, for example, a hard disk, a disk device, and/or the like.

From the foregoing description, it will be appreciated that the present embodiment of the multi-channel sound collecting apparatus according to the present invention can change a zoom of sounds while the sounds are reproduced, resulting from the fact that the sound collecting signal storing unit is operative to store therein sound signals of respective channels and the zoom control signal in such a manner that the sound signals of respective channels can be later read independent from the zoom control signal.

In addition, the present embodiment of the multi-channel sound collecting apparatus according to the present invention makes it possible for the sound signals to be reproduced along with a zoom changing function, thereby enhancing realistic sensation, easily responding to user's preference, resulting from the fact that sounds from a plurality of directions including a direction of taking the image are collected and recorded.

Further, the present embodiment of the multi-channel sound collecting apparatus according to the present invention can reduce additional storage area for storing therein the zoom control signal, resulting from the fact that the sound collecting signal storing unit is operative to store the zoom control signal in lower bits of a sound signal of any one of channels.

The present embodiment of multi-channel sound reproducing apparatus according to the present invention can change a zoom of sounds to any one of zooms such as, for example, a zoom at the time that the sounds are collected, a zoom set by a user including a passing through zoom, and the like, while the sounds are reproduced, resulting from the fact that the collected signal reading unit is operative to read a zoom control signal and sound signals of respective channels independent from one another, and the zoom reproducing mode and the predetermined reproducing mode can be switched through the mode switching unit.

In addition, the present embodiment of multi-channel sound reproducing apparatus according to the present invention makes it possible for the sound signals to be reproduced along with a zoom changing function, thereby enhancing realistic sensation, easily responding to user's preference, resulting from the fact that sounds collected from a plurality of directions including a direction of taking the image are read.

The present embodiment of multi-channel sound collecting and reproducing apparatus according to the present invention can change a zoom of sounds while the sounds are reproduced, resulting from the fact that the sound collecting signal storing unit is operative to store therein sound signals of respective channels and the zoom control signal in such a manner that the sound signals of respective channels can be later read independent from the zoom control signal, the collected signal reading unit is operative to read a zoom control signal and sound signals of respective channels independent from one another so that the zoom reproducing mode and the predetermined reproducing mode can be switched through the mode switching unit.

In addition, the present embodiment of multi-channel sound collecting and reproducing apparatus according to the present invention makes it possible for the sound signals to be reproduced along with a zoom changing function, thereby enhancing realistic sensation, easily responding to user's preference, resulting from the fact that sounds incoming from a plurality of directions including a direction of taking the image are collected and reproduced.

Further, the present embodiment of the multi-channel sound collecting and reproducing apparatus according to the present invention can reduce additional storage area for storing therein the zoom control signal, resulting from the fact that the sound collecting signal storing unit is operative to store the zoom control signal in lower bits of a sound signal of any one of channels.

### Second Preferred Embodiment

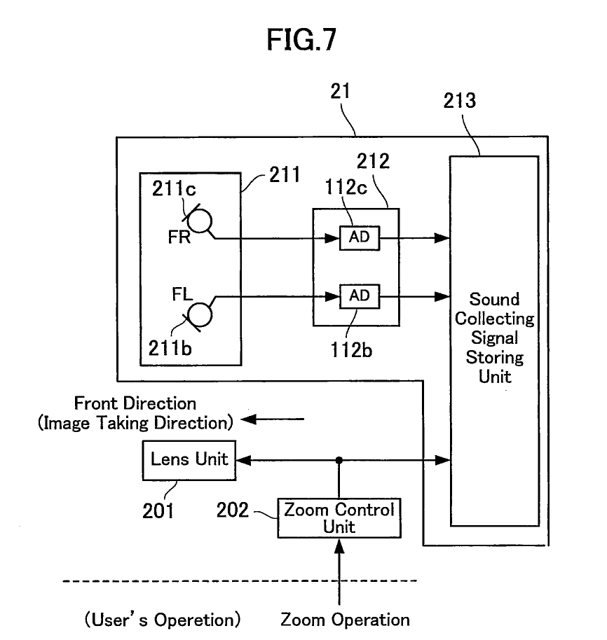

In a second embodiment of the multi-channel sound collecting apparatus according to the present invention, the multi-channel sound collecting unit is constituted by a stereo microphone having two directional microphones. FIG. 7 is a block diagram showing a construction of the present embodiment of the multi-channel sound collecting apparatus according to the present invention. The constitutional elements of the present embodiment of the multi-channel sound collecting apparatus 21 according to the present invention the same as those of the first embodiment of the multi-channel sound collecting apparatus 11 will not be described but bear the same reference numerals and legends as those of the first embodiment.

In the present embodiment, the multi-channel sound collecting unit 211 includes two directional microphones 211b and 211c, collectively constituting a stereo microphone having directivities in left and right directions. The multi-channel sound collecting unit 211 may be constituted by a plurality of non-directional and means for carrying out a predetermined signal processing such as, for example, phasing processing.

The directional microphone 211b is adapted to collect sounds incoming from the left of a direction of taking an image, and the directional microphone 211c is adapted to collect sounds incoming from the right of the direction of taking the image.

An analog-digital converting unit 212 includes analog-digital converting units 112b and 112c and has functions the same as those of the analog-digital converting unit 112 of the first embodiment. The analog-digital converting units 112b and 112c are adapted to convert analog sound signals respectively outputted from the directional microphones 211b and 211c into digital sound signals, to be outputted to a sound collecting signal storing unit 213.

The sound collecting signal storing unit 213 has functions the same as those of the sound collecting signal storing unit 113 of the first embodiment. The sound collecting signal storing unit 213 is adapted to store the digital sound signals outputted from the analog-digital converting unit 212 into channel specific storage areas.

The operation of the present embodiment of the multi-channel sound collecting apparatus according to the present invention is the same as that of the multi-channel sound collecting apparatus, and thus will be thus omitted from description hereinlater.

A second embodiment of the multi-channel sound reproducing apparatus according to the present invention is designed to reproduce sounds collected by the stereo microphone constituted by two directional microphones in accordance with a zoom operation at the time that the images are taken.

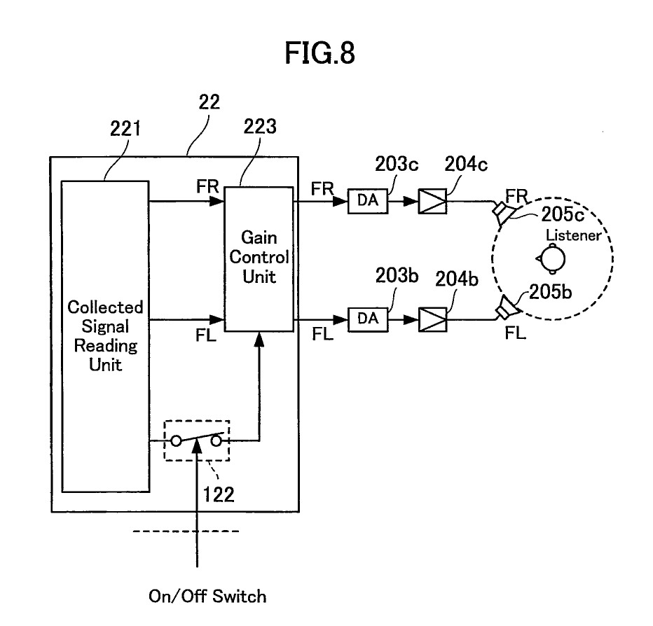

FIG. 8 is a block diagram showing a construction of the present embodiment of the multi-channel sound reproducing apparatus according to the present invention. The constitutional elements of the present embodiment of the multi-channel sound reproducing apparatus 22 according to the present invention the same as those of the first embodiment of the multi-channel sound reproducing apparatus 12 according to the present invention will not be described but bear the same reference numerals and legends as those of the first embodiment.

The collected signal reading unit 221 has functions the same as those of the collected signal reading unit 121 of the first embodiment except for the fact that the collected signal reading unit 221 is adapted to read sound signals of two channels while, on the other hand, the collected signal reading unit 121 is adapted to read sound signals of five channels.

A gain control unit 223 is adapted to control gains of sound signals respectively read by the collected signal reading unit 221 in accordance with the zoom control signal in the zoom reproducing mode in the same manner as described in the first embodiment. The gain control unit 223 is, on the other hand, adapted to control gains of the sound signals of channels respectively read by the collected signal reading unit 221 in accordance with a predetermined control method in the predetermined reproducing mode in the same manner as described in the first embodiment. The gain control unit 223 is different from that of the first embodiment in construction and signal processing as described hereinlater.

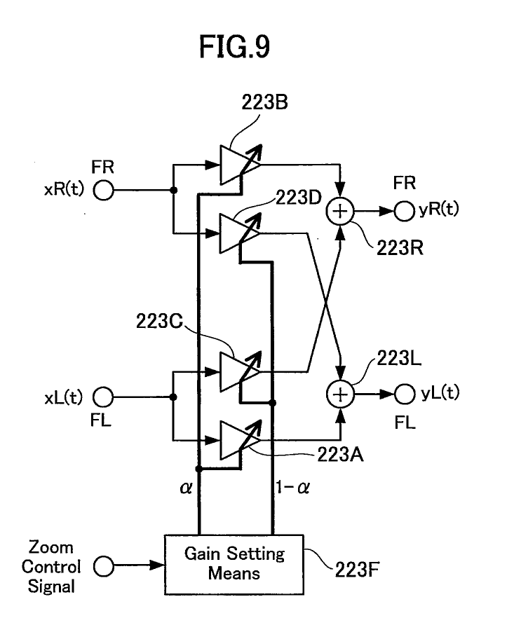

FIG. 9 is a block diagram showing an example of the gain control unit 223 of the present embodiment. As shown in FIG. 9, the gain control unit 223 includes a pair of multiplying devices 223A and 223C intended for the use of a left channel, a pair of multiplying devices 223B and 223D intended for the use of a right channel, a gain setting means 223F for setting a coefficient α to be multiplied by the multiplying devices 223A to 223D in accordance with the zoom control signal at the time that the images are taken, an adding device 223L for adding the outputs of the multiplying device 223A and the multiplying device 223D, an adding device 223R for adding the outputs of the multiplying device 223B and the multiplying device 223C, with the result that the gains of sound signals of respective channels are controlled and combined in accordance with the coefficient α set by the gain setting means 223F.

In the concrete, the gain control unit 223 is adapted to carry out a signal processing in accordance with expressions (2a) and (2b) as follows.

yL(t)=α×xL(t)+(1−α)×xR(t) (2a)

yR(t)=α×xR(t)+(1−α)×xL(t) (2b)

Here, xL(t) and xR(t) are intended to mean sounds respectively incoming from the left and right of the imaging device, viz., the direction of taking the image, yL(t) and yR(t) are intended to mean sounds respectively outgoing to left channel and right channel, a is intended to mean a coefficient multiplied by the multiplying devices 223A and 223B, and (1−α) is intended to mean a coefficient multiplied by the multiplying devices 223C and 223D.

This means that, in the gain control unit 223, the gain setting means 223F is operative to calculate the aforementioned coefficients α and (1−α) based on the zoom control signal, output the coefficient α to the multiplying devices 223A and 223B, and output the coefficient (1−α) to the multiplying devices 223C and 223D, the multiplying device 223A is operative to multiply the sound signal xL(t) by the coefficient α to generate a sound signal represented in the first term of the aforementioned expression (2a), the multiplying device 223C is operative to multiply the sound signal xL(t) by the coefficient (1−α) to generate a sound signal represented in the second term of the aforementioned expression (2a), the multiplying device 223B is operative to multiply the sound signal xR(t) by the coefficient α to generate a sound signal represented in the first term of the aforementioned expression (2b), the multiplying device 223D is operative to multiply the sound signal xR(t) by the coefficient (1−α) to generate a sound signal represented in the second term of the aforementioned expression (2b), the adding device 223L is adapted to add the output α×xL(t) from the multiplying device 223A and the output (1−α)×xR(t) from the multiplying device 223D, and output the result of the addition as a left channel output, and the adding device 223R is adapted to add the output α×xR(t) from the multiplying device 223B and the output (1−α)×xL(t) from the multiplying device 223C, and output the result of the addition as a right channel output.

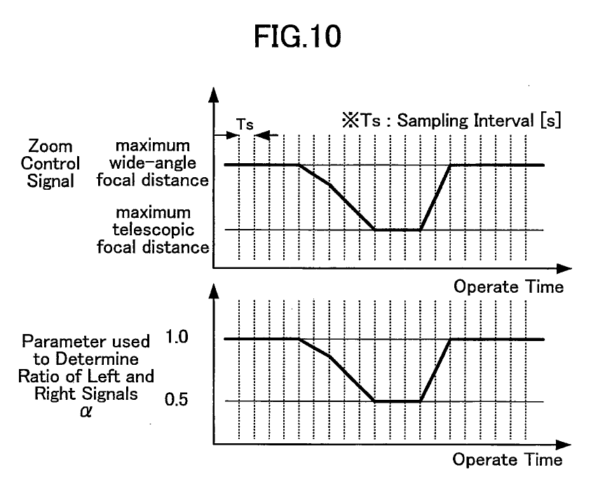

FIG. 10 is a graph explaining an example of a setting method of the aforementioned coefficient α. In FIG. 10, the coefficient α is set at “1” when the current zoom is set at the maximum wide-angle focal distance and the coefficient α is set at “0.5” when the current zoom is set at the maximum telescopic focal distance. The coefficient α is set in such a manner that the coefficient is near-continuously changed in accordance with the zoom control signal while the current zoom is changed between the maximum telescopic focal distance and the maximum wide-angle focal distance. The fact that the coefficient α is set at 0.5 when the current zoom is set at the maximum telescopic focal distance causes the sound signals to become monaural thereby enabling the sounds to be reproduced as if the sounds are from afar.

The operations of the multi-channel sound collecting apparatus 21 and the multi-channel sound reproducing apparatus 22 are the same as those of the multi-channel sound collecting apparatus 11 and the multi-channel sound reproducing apparatus 12 as described in the first embodiment, and thus will be omitted from the description hereinlater.

Though it has been described in the present embodiment that the multi-channel sound collecting apparatus 21 is adapted to store digital signals in a storage medium, and the multi-channel sound reproducing apparatus 22 is adapted to read the digital signals from the storage medium, to have the digital signals reproduced and outputted therethrough, this does not limit the present invention as described in the first embodiment. The present invention is applicable to the case that analog signals are stored in and read from a storage medium to have the analog signals reproduced, in the same way. In the case that the analog signals are stored, the analog-digital converting unit 212 is omitted in the multi-channel sound collecting apparatus 21, and in the case that the analog signals are reproduced, the digital-analog converting units 203a to 203e are omitted in the multi-channel sound reproducing apparatus 22.

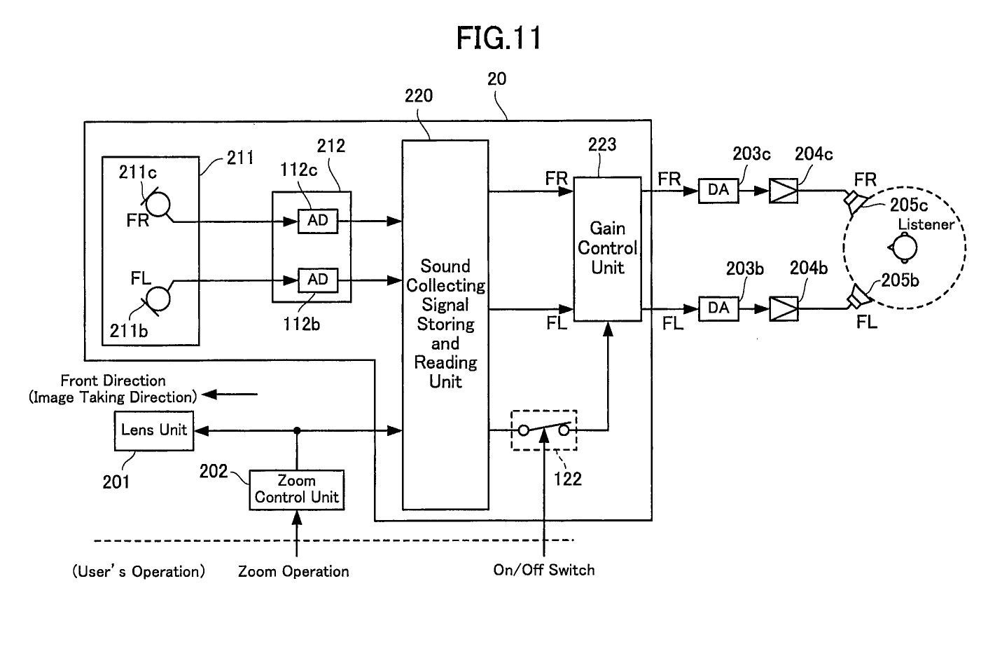

Further, though it has been described in the above that the multi-channel sound collecting apparatus 21 and the multi-channel sound reproducing apparatus 22 are separated from each other, the multi-channel sound collecting apparatus and the multi-channel sound reproducing apparatus may be integrated with each other, for example, as a single multi-channel sound collecting and reproducing apparatus shown in FIG. 11. In this case, the sound collecting signal storing unit 213 and the collected signal reading unit 221 may be constituted by, for example, a single sound collecting signal storing and reading unit 220 for storing therein sounds, voices or the like, as the sound collecting signal storing unit 213, and reading sound signals, as the collected signal reading unit 221. The single sound collecting signal storing and reading unit 220 may be constituted by, for example, a hard disk, a disk device, and/or the like.

From the foregoing description, it will be appreciated that the present embodiment of the multi-channel sound collecting apparatus according to the present invention makes it possible for the sound signals to be reproduced along with a zoom changing function, thereby enhancing realistic sensation, easily responding to user's preference, in addition to the effect of the first embodiment, resulting from the fact that sounds incoming from the left and right of the direction of taking the image are collected and recorded.

Further, it will be appreciated that the present embodiment of the multi-channel sound reproducing apparatus according to the present invention makes it possible for the sound signals to be reproduced along with a zoom changing function, thereby enhancing realistic sensation, easily responding to user's preference, in addition to the effect of the first embodiment, resulting from the fact that sounds collected from the left and right of the direction of taking the image are read.

The present embodiment of multi-channel sound collecting and reproducing apparatus according to the present invention makes it possible for the sound signals to be reproduced along with a zoom changing function, thereby enhancing realistic sensation, easily responding to user's preference, in addition to the effect of the first embodiment, resulting from the fact that sounds incoming from the left and right of the direction of taking the image are collected and reproduced.

### Third Preferred Embodiment

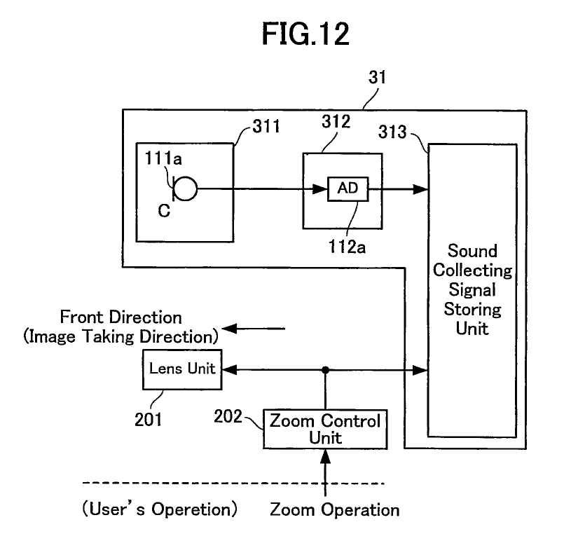

Referring to the FIG. 12 of the drawings, there is shown a third embodiment of a multi-channel sound collecting apparatus according to the present invention. The present embodiment of the multi-channel sound collecting apparatus 31 according to the present invention the same in construction and function as the first embodiment of the multi-channel sound collecting apparatus 11 except for the fact that monaural sounds are collected. The constitutional elements of the present embodiment of the multi-channel sound collecting apparatus 31 according to the present invention the same as those of the first embodiment of the multi-channel sound collecting apparatus 11 will not be described but bear the same reference numerals and legends as those of the first embodiment.

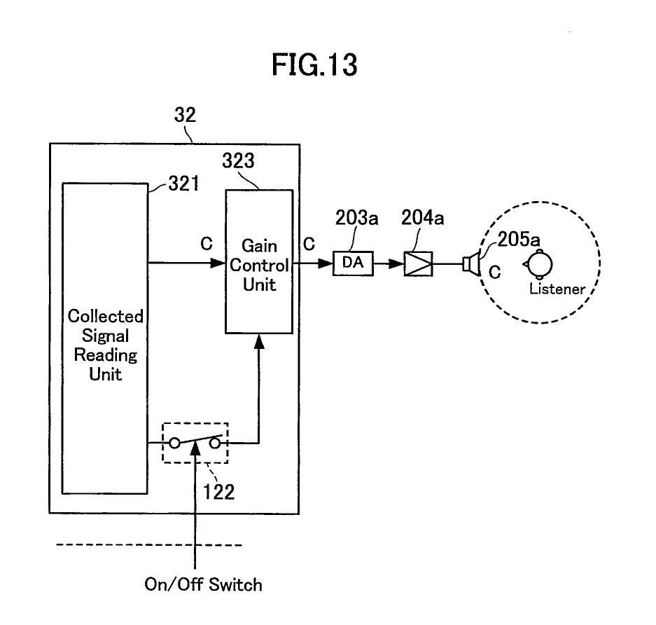

The present embodiment of multi-channel sound reproducing apparatus according to the present invention is constructed to reproduce the monaural sounds in accordance with a zoom operation at the time that the images are taken. FIG. 13 is a block diagram showing a construction of the present embodiment of multi-channel sound reproducing apparatus according to the present invention. The constitutional elements of the present embodiment of the multi-channel sound reproducing apparatus 32 according to the present invention the same as those of the first embodiment of the multi-channel sound reproducing apparatus 12 will not be described but bear the same reference numerals and legends as those of the first embodiment.

A collected signal reading unit 321 has functions the same as those of the collected signal reading unit 121 as described in the first embodiment except for the fact that the collected signal reading unit 221 is adapted to read monaural sound signals while, on the other hand, the collected signal reading unit 121 is adapted to read sound signals of five channels.

A gain control unit 323 is adapted to control gains of monaural sound signal read by the collected signal reading unit 321 in accordance with the zoom control signal in the zoom reproducing mode in the same manner as described in the first embodiment. The gain control unit 323 is, on the other hand, adapted to control gains of the monorail sound signal read by the collected signal reading unit 321 in accordance with a predetermined control method in the predetermined reproducing mode in the same manner as described in the first embodiment. The gain control unit 323 is different from that of the first embodiment in construction and signal processing as described hereinlater.

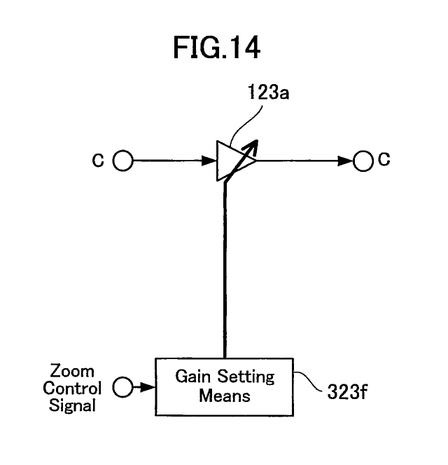

FIG. 14 is a block diagram showing an example of the gain control unit 323 of the present embodiment. As shown in FIG. 14, the gain control unit 323 includes a multiplying device 123a for multiplying a sound signal by a coefficient, and gain setting means 323F for setting the coefficient in accordance with a zoom state at the time that the images are taken. In the concrete, the gain setting means 323F is adapted to set the coefficient at “1” when the current zoom is set at the maximum wide-angle focal distance. The gain setting means 323F is adapted to set the coefficient at “2”, in order to express a zoom effect, when the current zoom is set at the maximum telescopic focal distance. Further, the coefficient is set in such a manner that the coefficient is near-continuously changed in accordance with the zoom state while the current zoom is changed between the maximum telescopic focal distance and the maximum wide-angle focal distance.

The operations of the multi-channel sound collecting apparatus 31 and the multi-channel sound reproducing apparatus 32 are the same as those of the multi-channel sound reproducing apparatus 11 and the multi-channel sound reproducing apparatus 12, as described in the first embodiment, and thus will be omitted from the description hereinlater.

Though it has been described in the present embodiment that the multi-channel sound collecting apparatus 31 is adapted to store digital signals in a storage medium, and the multi-channel sound reproducing apparatus 32 is adapted to read the digital signals from the storage medium, to have the digital signals reproduced and outputted therethrough, this does not limit the present invention as described in the first embodiment. The present invention is applicable to the case that analog signals are stored in and read from a storage medium to have the analog signals reproduced, in the same way. In the case that the analog signals are stored, the analog-digital converting unit 312 is omitted in the multi-channel sound collecting apparatus 31, and in the case that the analog signals are reproduced, the digital-analog converting units 203a to 203e are omitted in the multi-channel sound reproducing apparatus 32.

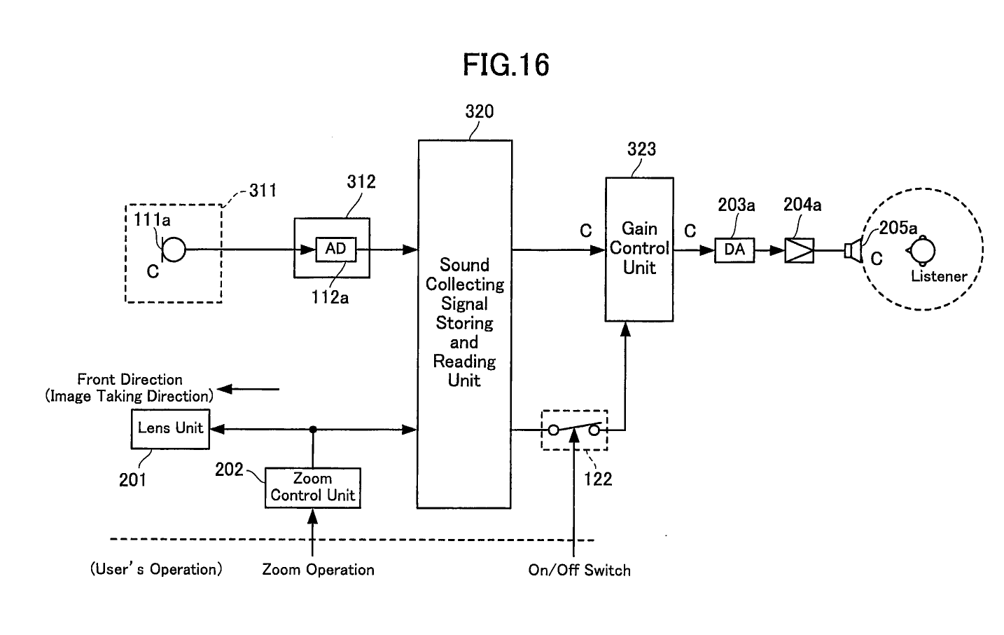

Further, though it has been described in the above that the multi-channel sound collecting apparatus 31 and the multi-channel sound reproducing apparatus 32 are separated from each other, the multi-channel sound collecting apparatus and the multi-channel sound reproducing apparatus may be integrated with each other, for example, as a single multi-channel sound collecting and reproducing apparatus shown in FIG. 16. In this case, the sound collecting signal storing unit 313 and the collected signal reading unit 321 may be constituted by, for example, a single sound collecting signal storing and reading unit 320 for storing therein sounds, voices or the like, as the sound collecting signal storing unit 313, and reading sound signals, as the collected signal reading unit 321. The single sound collecting signal storing and reading unit 230 may be constituted by, for example, a hard disk, a disk device, and/or the like.

From the foregoing description, it will be appreciated that the present embodiment of the multi-channel sound collecting apparatus according to the present invention can be manufactured in simple construction, in addition to the effect of the first embodiment, resulting from the fact that the multi-channel sound collecting unit is constituted by a single directional microphone.

The present embodiment of multi-channel sound reproducing apparatus according to the present invention can reproduce sounds of a single channel perceptively in accordance with a zoom state at the time that the sounds are collected, resulting from the fact that the gain of the sound signal to be reproduced is controlled in accordance with the zoom state.

The present embodiment of multi-channel sound collecting and reproducing apparatus according to the present invention makes it possible for sound signals of a single channel to be reproduced perceptively in accordance with a zoom state at the time that the sounds are collected, in addition to the effect of the first embodiment.

### Fourth Preferred Embodiment

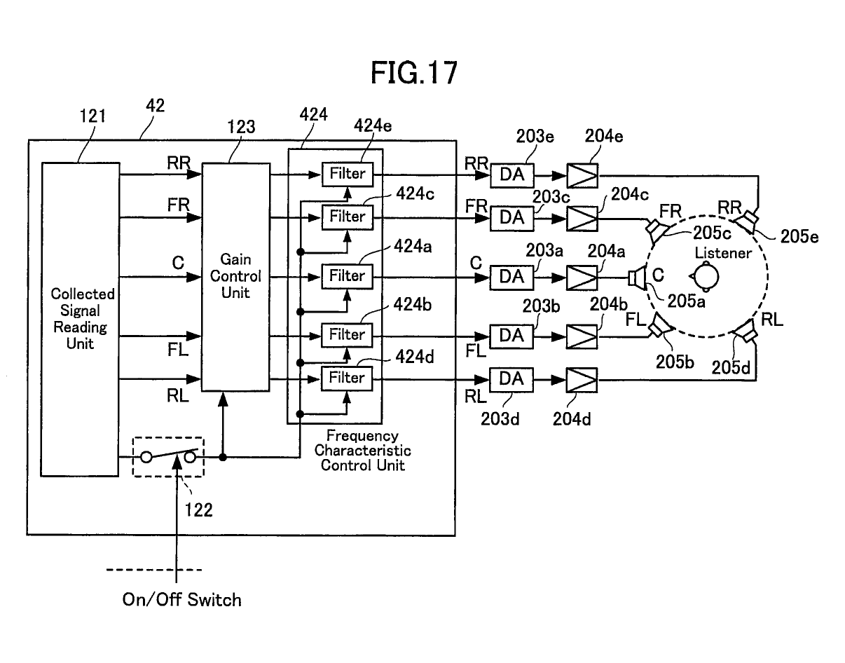

FIG. 17 is a block diagram showing a construction of a fourth embodiment of a multi-channel sound reproducing apparatus according to the present invention. The present embodiment of the multi-channel sound reproducing apparatus 42 according to the present invention is the same in construction and function as the first embodiment of the multi-channel sound reproducing apparatus 12 except for the fact that a frequency characteristic control unit 424 is provided and connected with the output side of the gain control unit 123. Constituent elements of the present embodiment of the multi-channel sound reproducing apparatus 42 according to the present invention the same as those of the first embodiment of multi-channel sound reproducing apparatus 12 according to the present invention will not be described but bear the same reference numerals and legends as those of the first embodiment.

The frequency characteristic control unit 424 includes digital filters 424a to 424e each of which is such as, for example, a well-known FIR (Finite Impulse Response) filter, a well-known IIR (Infinite Impulse Response) filter, or the like and provided for each of channels. The frequency characteristic control unit 424 thus constructed is adapted to set frequency spectra for respective channels. In the concrete, the frequency characteristic control unit 424 is adapted to carry out a filter processing on a sound incoming from a direction of taking the image and whose gain is set at relatively high value in such a manner that either or both of low components and high components of the sound are removed, emphasized, and/or the like, when the current zoom is set at the maximum telescopic focal distance. The frequency characteristic control unit 424 thus constructed can reproduce sounds with enhanced realistic sensation.

The operation of the multi-channel sound reproducing apparatus 42 is the same as that of the multi-channel sound reproducing apparatus 12 as described in the first embodiment, except for the fact that the frequency characteristic control unit 424 is adapted to carry out a predetermined filter processing, and thus will be omitted from the description hereinlater.

Though it has been described in the present embodiment that the multi-channel sound collecting apparatus 11 is adapted to store digital signals in a storage medium, and the multi-channel sound reproducing apparatus 42 is adapted to read the digital signals from the storage medium, to have the digital signals reproduced and outputted therethrough, this does not limit the present invention. The present invention is applicable to the case that analog signals are stored in and read from a storage medium to have the analog signals reproduced, in the same way.

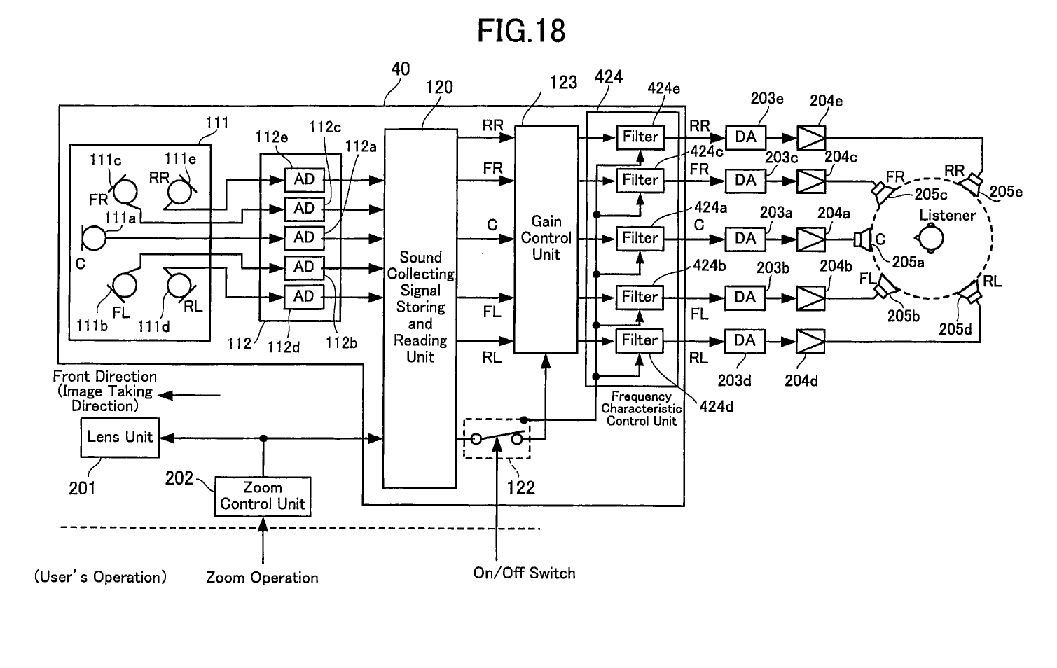

Further, though it has been described in the above that the multi-channel sound collecting apparatus 11 and the multi-channel sound reproducing apparatus 42 are separated from each other, the multi-channel sound collecting apparatus and the multi-channel sound reproducing apparatus may be integrated with each other, for example, as a single multi-channel sound collecting and reproducing apparatus shown in FIG. 18. In this case, the sound collecting signal storing unit 113 and the collected signal reading unit 121 may be constituted by, for example, a single sound collecting signal storing and reading unit 420 for storing therein sounds, voices or the like, as the sound collecting signal storing unit 113, and reading sound signals, as the collected signal reading unit 121. The single sound collecting signal storing and reading unit 420 may be constituted by, for example, a hard disk, a disk device, and/or the like.

From the foregoing description, it will be appreciated that the present embodiment of the multi-channel sound reproducing apparatus according to the present invention makes it possible for realistic sensation to be expressed in accordance with a zoom state, in addition to the effect of the first embodiment, resulting from the fact that the frequency characteristic control unit is operative to control the frequency spectra of sound signals of respective channels.

The present embodiment of the multi-channel sound collecting and reproducing apparatus according to the present invention makes it possible for realistic sensation to be expressed in accordance with a zoom state, in addition to the effect of the first embodiment, resulting from the fact that the frequency characteristic control unit is operative to control the frequency spectra of sound signals of respective channels.

### INDUSTRIAL APPLICABILITY OF THE PRESENT INVENTION

The multi-channel sound collecting apparatus, the multi-channel sound reproducing apparatus, and the multi-channel sound collecting and reproducing apparatus according to the present invention have effects of storing into a storage medium sound signals and a zoom control signal in synchronization with the time at which the imaging device is zoom-operated and the time at which the multi-channel sound collecting unit collects the sounds and capable of controlling the sound signals in accordance with the zoom control signal when the sounds are reproduced, and are available as, for example, a multi-channel sound collecting apparatus, a multi-channel sound reproducing apparatus, and a multi-channel sound collecting and reproducing apparatus.

1. A multi-channel sound collecting apparatus, comprising:
a multi-channel sound collecting unit for collecting sounds incoming from a circumstance of an imaging device capable of operatively zooming in and out an image, and generating sound signals indicative of said sounds; and
a sound collecting signal storing unit for receiving a zoom control signal from said imaging device, and a sound signal from said multi-channel sound collecting unit, and storing into a storage medium said zoom control signal and said sound signal in synchronization with the time at which said imaging device is zoom-operated and the time at which said multi-channel sound collecting unit collects said sound.

2. A multi-channel sound collecting apparatus as set forth in claim 1, in which
said multi-channel sound collecting unit includes a plurality of directional microphones for collecting sounds incoming from a plurality of directions of said circumstance of

3. A multi-channel sound collecting apparatus as set forth in claim 1, in which
said multi-channel sound collecting unit includes a pair of directional microphones for collecting sounds incoming from left and right directions of said imaging device.

4. A multi-channel sound collecting apparatus as set forth in claim 1, in which
said multi-channel sound collecting unit includes a directional microphone for collecting sounds from an image taking direction of said imaging device.

5. A multi-channel sound collecting apparatus as set forth in claim 1, in which
said sound collecting signal storing unit is operative to multiplex said sound signal with said zoom control signal, and store said sound signal multiplexed with said zoom signal into said storage medium.

6. A multi-channel sound reproducing apparatus comprising:
a collected signal reading unit for reading a zoom control signal and a sound signal from a storage medium;
a gain control unit for controlling said sound signal for each of channels; and
a mode switching unit for assuming a plurality of states including a state of allowing said gain control unit to receive said zoom control signal from said collected signal reading unit, to have said gain control unit operate in a zoom reproducing mode, and a state disallowing said gain control unit to receive said zoom control signal from said collected signal reading unit, to have said gain control unit operate in a predetermined reproducing mode.

7. A multi-channel sound reproducing apparatus as set forth in claim 6, in which
said gain control unit includes a multiplying device for multiplying said sound signal by a gain, and gain setting means for setting said gain in accordance with said zoom control signal.

8. A multi-channel sound reproducing apparatus as set forth in claim 6, in which
said control unit is operative to set a gain of a sound signal indicative of a sound from an image taking direction higher than gains of sound signals indicative of sounds from directions other than said image taking direction, when reproducing sounds which were collected while a lens of said imaging device was placed at a maximum telescopic focal distance.

9. A multi-channel sound reproducing apparatus as set forth in claim 6, in which
said control unit is operative to set gains of a pair of sound signals respectively indicative of sounds from left and right directions of said imaging device in such a manner that said pair of sound signals are reproduced in stereo, when reproducing sounds which were collected while a lens of said imaging device was placed at a maximum wide-angle focal distance, and
said control unit is operative to set gains of said pair of sound signals respectively indicative of sounds from left and right directions of said imaging device in such a manner that said pair of sound signals are reproduced in monaural, when reproducing sounds which were collected while a lens of said imaging device was placed at a maximum telescopic focal distance.

10. A multi-channel sound reproducing apparatus as set forth in claim 6, in which
said control unit is operative to set gains of a plurality of sound signals respectively indicative of a plurality of sounds of a circumstance of said imaging device in accordance with said zoom control signal read from said storage medium, when reproducing sounds which were collected while a lens of said imaging device was placed in between maximum wide-angle focal distance and a maximum telescopic focal distance.

11. A multi-channel sound reproducing apparatus as set forth in any one of claim 6 through claim 10, which further comprises a frequency characteristic control unit for controlling frequency spectra of sound signals outputted from said gain control unit for respective channels.

12. A multi-channel sound collecting and reproducing apparatus, comprising:
a multi-channel sound collecting unit, mounted on an imaging device capable of operatively zooming in and out an image, for collecting sounds incoming from a circumstance of said imaging device, and generating sound signals indicative of said sounds;
a sound collecting signal storing and reading unit for receiving a zoom control signal from said imaging device and a sound signal from said multi-channel sound collecting unit, and storing into a storage medium said zoom control signal and said sound signal in synchronization with the time at which said imaging device is zoom-operated and the time at which said multi-channel sound collecting unit collects said sound, and reading said zoom control signal and said sound signal from said storage
a gain control unit for controlling said sound signal for each of channels; and
a mode switching unit for assuming a plurality of states including a state of allowing said gain control unit to receive said zoom control signal from said sound collecting signal storing and reading unit, to have said gain control unit operate in a zoom reproducing mode, and a state disallowing said gain control unit to receive said zoom control signal from said sound collecting signal storing and reading unit, to have said gain control unit operate in a predetermined reproducing mode, and in which
said gain control unit is operative to control said sound signal for each of channels in accordance with said zoom control signal when said mode switching unit assumes on said zoom reproducing mode and control said sound signal for each of channels in accordance with a predetermined control method when said mode switching unit assumes on said predetermined reproducing mode.

13. A multi-channel sound collecting and reproducing apparatus as set forth in claim 12, in which
said gain control unit includes a multiplying device for multiplying said sound signal by a gain, and gain setting means for setting said gain in accordance with said zoom control signal.

14. A multi-channel sound collecting and reproducing apparatus as set forth in claim 12, in which
said multi-channel sound collecting unit includes a plurality of directional microphones for collecting sounds incoming from a plurality of directions of said circumstance of said imaging device.

15. A multi-channel sound collecting and reproducing apparatus as set forth in claim 12, in which
said multi-channel sound collecting unit includes a pair of directional microphones for collecting sounds incoming from left and right directions of said imaging device.

16. A multi-channel sound collecting and reproducing apparatus as set forth in claim 12, in which
said multi-channel sound collecting unit includes a directional microphone for collecting sounds from an image taking direction of said imaging device.

17. A multi-channel sound collecting and reproducing apparatus as set forth in claim 12, in which
said sound collecting signal storing unit is operative to multiplex said sound signal with said zoom control signal, and store said sound signal multiplexed with said zoom signal into said storage medium.

18. A multi-channel sound collecting and reproducing apparatus as set forth in claim 12, in which
said control unit is operative to set a gain of a sound signal indicative of a sound from an image taking direction higher than gains of sound signals indicative of sounds from directions other than said image taking direction, when reproducing sounds which were collected while a lens of said imaging device was placed at a maximum telescopic focal distance.

19. A multi-channel sound collecting and reproducing apparatus as set forth in claim 12, in which
said control unit is operative to set gains of a pair of sound signals respectively indicative of sounds from left and right directions of said imaging device in such a manner that said pair of sound signals are reproduced in stereo, when reproducing sounds which were collected while a lens of said imaging device was placed at a maximum wide-angle focal distance, and
said control unit is operative to set gains of said pair of sound signals respectively indicative of sounds from left and right directions of said imaging device in such a manner that said pair of sound signals are reproduced in monaural, when reproducing sounds which were collected while a lens of said imaging device was placed at a maximum telescopic focal distance.

20. A multi-channel sound collecting and reproducing apparatus as set forth in claim 12, in which
said control unit is operative to set gains of a plurality of sound signals respectively indicative of a plurality of sounds of a circumstance of said imaging device in accordance with said zoom control signal read from said storage medium, when reproducing sounds which were collected while a lens of said imaging device was placed in between maximum wide-angle focal distance and a maximum telescopic focal distance.

21. A multi-channel sound collecting and reproducing apparatus as set forth in any one of claim 12 through claim 20, which further comprises a frequency characteristic control unit for controlling frequency spectra of sound signals outputted from said gain control unit for respective channels.
